(19) United States
(12) Patent Application Publication
(10) Pub. No.: US 2018/0357826 A1
(43) Pub. Date: Dec. 13, 2018

(54) SYSTEMS AND METHODS FOR USING HIERARCHICAL RELATIONSHIPS OF DIFFERENT VIRTUAL CONTENT TO DETERMINE SETS OF VIRTUAL CONTENT TO GENERATE AND DISPLAY

(71) Applicant: Tsunami VR, Inc., Del Mar, CA (US)

(72) Inventors: David ROSS, San Diego, CA (US); Beth BREWER, Escondido, CA (US)

(21) Appl. No.: 16/000,835

(22) Filed: Jun. 5, 2018

Related U.S. Application Data
(60) Provisional application No. 62/517,900, filed on Jun. 10, 2017.

(51) Int. Cl. G06T 19/00; G06K 9/00; G06T 13/20; G06F 3/01; G06F 3/0481; G06F 3/0484

(52) U.S. Cl. CPC G06T 19/006; G06K 9/00671; G06T 13/20; G06F 3/04842; G06F 3/014; G06F 3/04815; G06F 3/013

(57) ABSTRACT

Using hierarchical relationships of different virtual content to determine sets of virtual content to generate and display on a virtual reality, augmented reality, or other user device. Particular embodiments include systems and methods that determine when a first user operating a first user device selects a first object of an environment, identifying the first object from among a plurality of objects, and determine if a plurality of parts of virtual content are stored in association with the first object. If the plurality of parts of the virtual content are stored in association with the first object, the particular embodiments transmit the plurality of parts of the virtual content to the first user device for display of the plurality of parts of the virtual content by the first user device, determine when the first user operating the first user device selects a first part of the virtual content from among the plurality of parts of the virtual content, and determine if one or more subparts of the first part of the virtual content are stored in association with the first part of the virtual content. If the one or more subparts of the first part of the virtual content are stored in association with the first part of the virtual content, the systems and methods transmit the one or more subparts of the first part of the virtual content to the first user device for display of the one or more subparts of the first part of the virtual content by the first user device.

### TECHNICAL FIELD

This disclosure relates to virtual reality (VR), augmented reality (AR), and mixed reality (MR) technologies.

### BRIEF DESCRIPTION OF THE DRAWINGS

FIG. 1A and FIG. 1B depict aspects of a system on which different embodiments are implemented for using hierarchical relationships of different virtual content to determine sets of virtual content to generate and display on a virtual reality, augmented reality, or other user device.

FIGS. 2A and 2B depict and illustrate a process for using hierarchical relationships of different virtual content to determine sets of virtual content to generate and display on a virtual reality, augmented reality, or other user device.

FIG. 3 illustrates a hierarchy in accordance with certain embodiments.

### DETAILED DESCRIPTION

This disclosure relates to different approaches for using hierarchical relationships of different virtual content to determine sets of virtual content to generate and display on a virtual reality, augmented reality, or other user device.

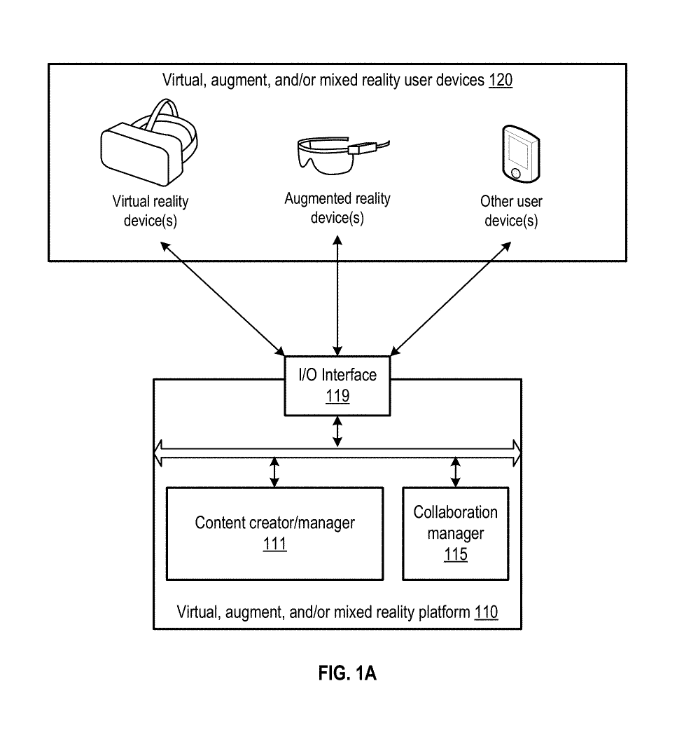

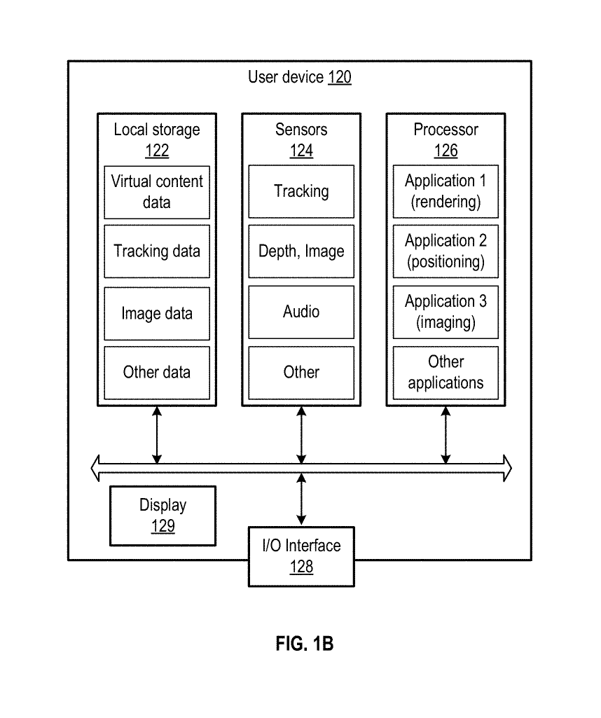

FIG. 1A and FIG. 1B depict aspects of a system on which different embodiments are implemented for using hierarchical relationships of different virtual content to determine sets of virtual content to generate and display on a virtual reality, augmented reality, or other user device. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for using hierarchical relationships of different virtual content to determine sets of virtual content to generate and display on a virtual reality, augmented reality, or other user device are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for using hierarchical relationships of different virtual content to determine sets of virtual content to generate and display on a virtual reality, augmented reality, or other user device.

Using hierarchical relationships of different virtual content to determine sets of virtual content to generate and display on a virtual reality, augmented reality, or other user device

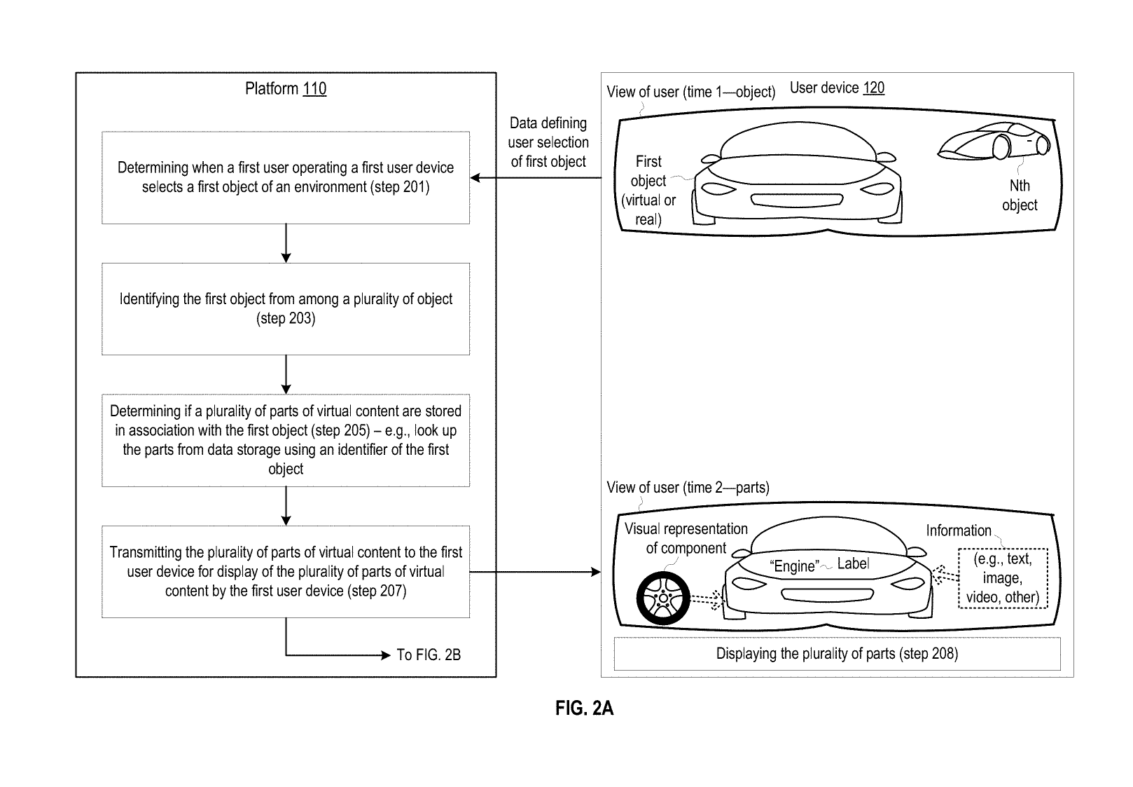

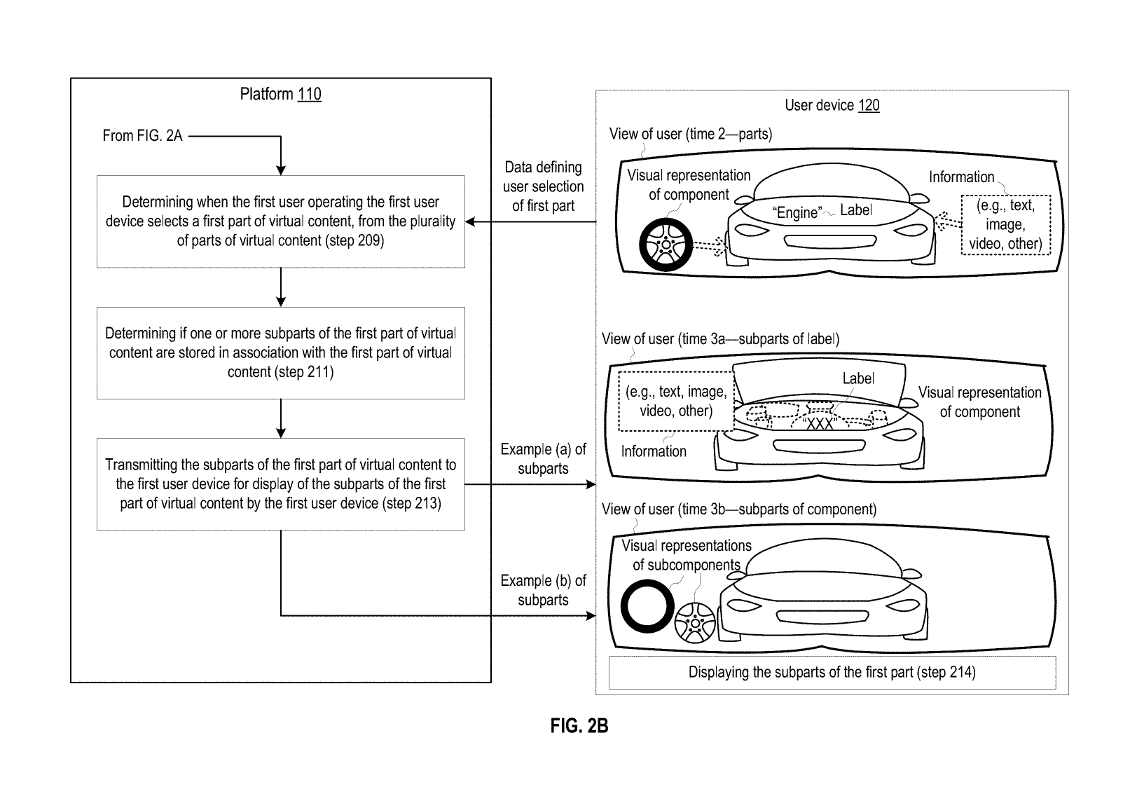

FIG. 2A and FIG. 2B depict and illustrate a method for using hierarchical relationships of different virtual content to determine sets of virtual content to generate and display on a virtual reality, augmented reality, or other user device.

The method shown in FIG. 2A and FIG. 2B is shown to comprise the steps of: determining when a first user operating a first user device selects a first object of an environment (step 201); identifying the first object from among a plurality of objects (step 203); determining if a plurality of parts of virtual content are stored in association with the first object (step 205) (e.g., using an identifier of the first object to look up the virtual content); if the plurality of parts of the virtual content are stored in association with the first object, transmitting the plurality of parts of the virtual content to the first user device for display of the plurality of parts of the virtual content by the first user device (step 207); determining when the first user operating the first user device selects a first part of the virtual content, from among the plurality of parts of the virtual content (step 209); determining if one or more subparts of the first part of the virtual content are stored in association with the first part of the virtual content (step 211) (e.g., using an identifier of the first part to look up the subparts); and if the one or more subparts of the first part of the virtual content are stored in association with the first part of the virtual content, transmitting the one or more subparts of the first part of the virtual content to the first user device for display of the one or more subparts of the first part of the virtual content by the first user device (step 213).

By way of example, approaches for identifying the first object include: receiving an image of the first object and using any known image analysis process to identify the first object as a predefined object; scanning a code on or near the first object, and looking up the first object using the code; receiving a signal from the first object that includes an identifier of the first object, and using the identifier to identify the first object; receiving user input from the user that identifies the first object; or any other approach.

In one embodiment of the method shown in FIG. 2A and FIG. 2B, the method further comprises: displaying, on a screen of the first user device, the first part of the virtual content along with other parts of the plurality of parts of the virtual content; and displaying, on the screen of the first user device, the one or more subparts of the first part of the virtual content. By way of example, the different parts of the plurality of parts may be displayed so as to appear as overlaying the object and/or positioned adjacent to (e.g., at predefined locations relative to, or within a predefined distance from) the object when the object is a real or virtual object, or the different parts of the plurality of parts may be displayed in place of or inside the object when the object is a virtual object.

In one embodiment of the method shown in FIG. 2A and FIG. 2B, the virtual content includes a virtual representation of the first object.

In one embodiment of the method shown in FIG. 2A and FIG. 2B, the plurality of parts of the virtual content include text, images, video, audio, static or animated visual representations of components of the first object (e.g., parts of a virtual model of the object), or other visual representation of data associated with the first object (e.g., labels of different components of the object on which any user can focus as a way to select the one or more subparts that include additional virtual content about that component).

In one embodiment of the method shown in FIG. 2A and FIG. 2B, the plurality of parts of the virtual content include visual representations of two or more components of the first object, the first part of the virtual content comprises a first visual representation of a first component of the first object, and the one or more subparts include one or more visual representation of one or more subcomponents of the first component.

In one embodiment of the method shown in FIG. 2A and FIG. 2B, the plurality of parts of the virtual content include visual representations of two or more components of the first object, the first part of the virtual content comprises a first visual representation of a first component of the first object, and the one or more subparts include one or more of text, image, video or audio about the first component.

In one embodiment of the method shown in FIG. 2A and FIG. 2B, the environment is a real environment, and the first object is a real object in the real environment.

In one embodiment of the method shown in FIG. 2A and FIG. 2B, the environment is a virtual environment, and the first object is a virtual object in the virtual environment.

In one embodiment of the method shown in FIG. 2A and FIG. 2B, the environment is a real environment, and the first object is a virtual object displayed to appear as if the virtual object is in the real environment.

In one embodiment of the method shown in FIG. 2A and FIG. 2B, the step of determining when the first user operating the first user device selects the first object or the first part comprises: determining if a gaze of the first user intersects with the first object or the first part for a predefined amount of time; and if the gaze of the first user intersects with the first object or the first part for the predefined amount of time, determining that the first object or the first part is selected by the first user.

In one embodiment of the method shown in FIG. 2A and FIG. 2B, the step of determining when the first user operating the first user device selects the first object or the first part comprises: determining if a gesture or audio input by the first user selects the first object or the first part; and if a determination is made that the audio input by the first user selects the first object or the first part, determining that the first object or the first part is selected by the first user. Examples of determining if a gesture or audio input by the first user selects the first object or the first part include: detecting a gesture, and determining that the gesture is a selection gesture and that the gesture was made for the first object and not any other object, or the first part and not any other parts; detecting an audio input by the first user, and determining that the audio input identifies the first object or the first part and designates selection of the first object or the first part.

In one embodiment of the method shown in FIG. 2A and FIG. 2B, the step of determining when the first user operating the first user device selects the first object or the first part comprises: determining if input by the first user generated using a glove, a controller or other peripheral device selects the first object or the first part; and if a determination is made that the input by the first user generated using the glove, the controller or the other peripheral device selects the first object or the first part, determining that the first object or the first part is selected by the first user. Examples of determining if input by the first user generated using a glove, a controller or other peripheral device selects the first object or the first part include: detecting an input generated by the first user using the peripheral device, and determining that the input identifies the first object or the first part, and designates selection of the first object or the first part.

In one embodiment of the method shown in FIG. 2A and FIG. 2B, the step of determining when the first user operating the first user device selects the first object or the first part comprises: determining if a condition is met; and if the condition is met, determining that the first object or the first part is selected by the first user.

In one embodiment of the method shown in FIG. 2A and FIG. 2B, the condition is determined to have been met when a position of the first user in the environment is within a predefined distance of a position of the first object or the first part in the environment.

In one embodiment of the method shown in FIG. 2A and FIG. 2B, the condition is determined to have been met when the first object or the first part is inside a field of view of the first user.

In one embodiment of the method shown in FIG. 2A and FIG. 2B, the condition is determined to have been met when the first user moves from an initial position of the first user in the environment towards the first object or the first part.

In one embodiment of the method shown in FIG. 2A and FIG. 2B, the first object is among a plurality of objects in the environment.

In one embodiment of the method shown in FIG. 2A and FIG. 2B, the method comprises: determining when a second user operating a second user device selects the first object; transmitting the plurality of parts of the virtual content to the second user device for display of the plurality of parts of the virtual content by the second user device; determining when the second user operating the second user device selects a second part of the virtual content, from the plurality of parts of the virtual content; determining if one or more subparts of the second part of the virtual content are stored in association with the second part of the virtual content; and if the one or more subparts of the second part of the virtual content are stored in association with the second part of the virtual content, transmitting the subparts of the second part of the virtual content to the second user device for display of the subparts of the second part of the virtual content by the second user device.

In one embodiment of the method shown in FIG. 2A and FIG. 2B, the method comprises: determining when the first user operating the first user device selects a second part of the virtual content, from the plurality of parts of the virtual content; determining if one or more subparts of the second part of the virtual content are stored in association with the second part of the virtual content; and if the one or more subparts of the second part of the virtual content are stored in association with the second part of the virtual content, transmitting the subparts of the second part of the virtual content to the first user for display of the subparts of the second part of the virtual content by the first user device.

### OTHER EMBODIMENTS

Training using augmented reality or mixed reality environments can be improved.

General definitions used in this section include the following: Virtual Reality (“VR”) is generally defined as an artificially created environment generated with a computer, and experienced by the sensory stimulation (visually, audibly, . . . etc.) of a user; Head Mounted Display (“HMD”) is a visual display mounted to a user's head; Augmented Reality (“AR”) is generally defined as an environment that combines visual images (graphical, symbolic, alphnumerics, . . . etc.) with a user's real view; Mixed Reality (“MR”) is generally defined as a combination of the real world, VR and AR.

There is a need to improve training using AR and MR.

The purpose of embodiments in this section is to be able to have software that can identify objects in a user's view and present information about the objects. The embodiments in this section focus on objects that are comprised of multiple other objects/components allowing each component of the high level object to be identified by the software. Having a hierarchy of objects that are automatically identifiable allows a user to be automatically presented with detailed information about each composite object and empowers the user to dissect an object into its composite objects and learn more details about the composition and interworking of the objects. The embodiments in this section will benefit the training, operations and maintenance personnel by providing detailed information about the objects the personnel needs to maintain as well as reduce the amount of time to service an object given the specifications, maintenance procedures and repair manuals can be presented automatically to the user using the embodiments in this section within the augmented reality environment.

The embodiments in this section leverage current aspects of target recognition technology to locate and identify an object. Once the high level object is identified, a list of possible composite objects is retrieved. The target recognition software then attempts to locate and identify one or more of the composite objects. When a composite object is recognized the system retrieves and presents information about the composite object as well as retrieving a list of composite objects for the identified object.

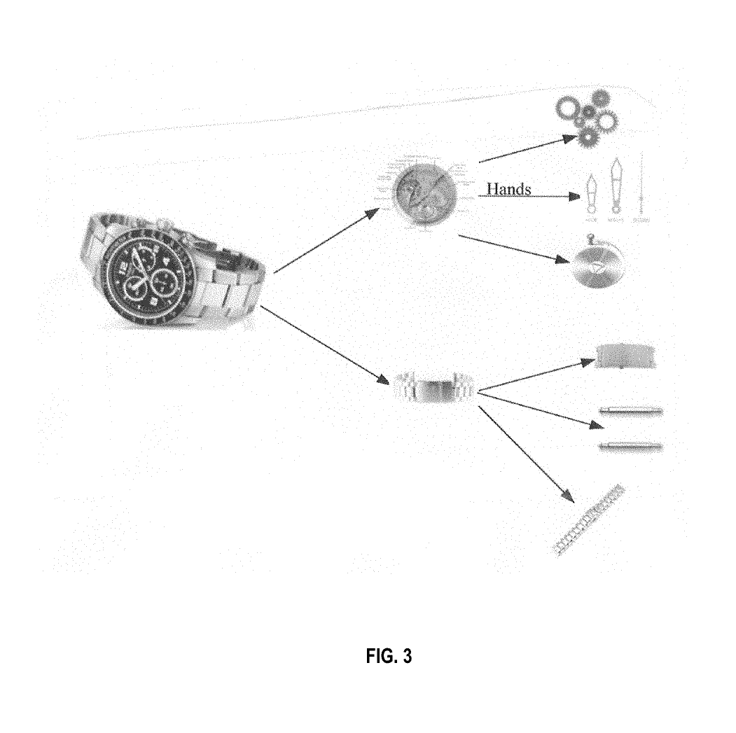

FIG. 3 illustrates an example hierarchy in accordance with certain embodiments. In the example the watch can be dissected to each of its individual parts. The watch is the high level target object, once located/identified, the user is shown a list of composite objects, the face and the band, as in the example. When the user focuses (using head movement, eye scanning, hand gesture, or pointer) on the band, the software recognizes the object the user is focusing on is the watch band and displays information relating to the band as well as retrieving a list of composite objects for the band. The software continues scanning the area based on where the user is focusing for recognized composite objects, i.e. the clasp, pins, or band links. Once the software detects one or more of the composite objects, the data associated with those objects is displayed for the user to view. Since the clasp, pins and links in this scenario are not comprised of other objects, the software does not scan for composite objects.

The embodiments in this section enable a user to dissect an object into its composite parts by simply looking at the object. The system recognizes the object and displays information about the object as well as continuing to scan for recognized composite objects. For each composite object identified, the system can also automatically display information associated with the composite parts. The information can include specifications, user guide, repair instructions, videos, etc. As each composite part is recognized, the system displays the information about each composite object as well as determine if that object consists of other composite objects. The software continues to traverse the hierarchy of objects until an object is reached that is not made of multiple parts or the user terminates the search.

The embodiments in this section use target recognition algorithms that are well known such as comparing preloaded images of the object to the real-world object, RFID, bar codes, or object location to detect an object. Once that target object is recognized, the system uses preloaded knowledge that identifies the composite parts of the target object. The system uses the preloaded knowledge to start searching for the composite parts of the target object. The system can use the user's behavior (i.e. head movement, eye movement, hand gestures, etc) to determine how to prioritize the scanning for composite objects. For example a maintenance crew member is in an airplane hangar and looking for a jet perform routine maintenance on. The crew member looks for the jet and once the jet is located/identified, the crew member approaches the cockpit of the jet in order to perform maintenance in the cockpit. The software detects the crew member is focused on the cockpit and therefore, loads data associated with the parts of the cockpit in order to start targeting objects within the cockpit.

The object hierarchy can contain objects that are directly related to each other, for example the composite parts of an object, or the hierarchy can contain objects that have a relationship to one another but are not necessary composite parts of each other, for example an airplane hangar contains airplanes.

One embodiment of this section is a method for identifying and using a hierarchy of targets in an augmented reality (“AR”) environment.

The method includes identifying an object in an AR environment, the object focused on by a user wearing an AR head mounted display (“HMD”) device, the AR HMD device comprising a processor, a camera, a memory, a software application residing in the memory, an eye tracking component, an IMU, and a display screen. The method also includes viewing a plurality of composite objects of the object through the field of view of the HMD device. The method also includes focusing on a single composite object of the plurality of composite objects. The method also includes recognizing the single composite object at the software application. The method also includes displaying data for the single composite object and a plurality of sub-composite objects for the single composite object on the display screen of the HMD device. The method also includes focusing on a single sub-composite object of the plurality of sub-composite objects. The method also includes recognizing the single sub-composite object of the plurality of sub-composite objects at the software application. The method also includes displaying data for the single sub-composite object on the display screen of the HMD device.

Another embodiment of this section is a method for identifying and using a hierarchy of targets in a MR environment. The method includes identifying an object in a MR environment, the object focused on by a user wearing a head mounted display (“HMD”) device, the HMD device comprising a processor, a camera, a memory, a software application residing in the memory, an eye tracking component, an IMU, and a display screen. The method also includes viewing a plurality of composite objects of the object through the field of view of the HMD device. The method also includes focusing on a single composite object of the plurality of composite objects. The method also includes recognizing the single composite object at the software application. The method also includes displaying data for the single composite object and a plurality of sub-composite objects for the single composite object on the display screen of the HMD device. The method also includes focusing on a single sub-composite object of the plurality of sub-composite objects. The method also includes recognizing the single sub-composite object of the plurality of sub-composite objects at the software application. The method also includes displaying data for the single sub-composite object on the display screen of the HMD device.

Alternatively, the method further comprises determining if the single composite object consists of the plurality of sub-composite objects. Alternatively, the method further comprises determining if the single sub-composite object consists of multiple parts. Alternatively, the method further comprises terminating a hierarchy search of the AR object.

The software application preferably comprises a target recognition algorithm.

Identifying an object preferably comprises using the eye-tracking component and/or the camera of the HMD device. In one embodiment, identifying an object comprises using a pointer component and the camera of the HMD device. Alternatively, identifying an object comprises using the IMU to determine movement of the HMD device. Alternatively, identifying an object comprises using a hand gesture of an AR or MR glove component.

Focusing on a single composite object preferably comprises using the eye-tracking component of the HMD device. Alternatively, focusing on a single composite object comprises using a pointer component of the HMD device. Alternatively, focusing on a single composite object comprises using the IMU to determine movement of the HMD device. Alternatively, focusing on a single composite object comprises using a hand gesture of an AR or MR glove component.

Focusing on a single sub-composite object comprises using the eye-tracking component of the HMD device. Alternatively, focusing on a single sub-composite object comprises using a pointer component of the HMD device. Alternatively, focusing on a single sub-composite object comprises using the IMU to determine movement of the HMD device. Alternatively, focusing on a single sub-composite object comprises using a hand gesture of an AR or MR glove component.

In another embodiment, a system for identifying and using a hierarchy of targets in an AR or MR environment comprises a collaboration manager at a server, and an head mounted display (“HMD”) device comprising a processor, a camera, a memory, a software application residing in the memory, an eye tracking component, an IMU, and a display screen. The eye tracking component and the camera are utilized to identify an object in an AR or MR environment. A plurality of composite objects of the object are viewed within a field of view of the HMD device. The eye tracking component is configured to focus on a single composite object of the plurality of composite objects. The software application is configured to recognize the single composite object at the software application. The software application is configured to display data for the single composite object and a plurality of sub-composite objects for the single composite object on the display screen of the HMD device. The eye tracking component is configured to focusing on a single sub-composite object of the plurality of sub-composite objects. The software application is configured to recognize the single sub-composite object of the plurality of sub-composite objects at the software application. The software application is configured to display data for the single sub-composite object on the display screen of the HMD device. In one embodiment, the software application is configured to determine if the single composite object consists of the plurality of sub-composite objects. In one embodiment, the software application is configured to determine if the single sub-composite object consists of multiple parts. In one embodiment, the software application is configured to terminate a hierarchy search of the object. In one embodiment, the software application comprises a target recognition algorithm. In one embodiment, the collaboration manager is configured to provide a plurality of AR or MR objects.

Alternatively, the system comprises an AR or MR hand component. The AR or MR hand component is preferably an AR or MR glove or an AR or MR pointer.

In another embodiment, a system for identifying and using a hierarchy of targets in an AR environment comprises a collaboration manager at a server, a client device and a HMD structured to hold the client device with the display screen of the client device over the eyes of the user. The client device comprises a processor, a camera, a memory, a software application residing in the memory, an eye tracking component, an IMU, and a display screen. The eye tracking component and the camera are utilized to identify an object in an AR or MR environment. A plurality of composite objects of the object are viewed within a field of view of the HMD device. The eye tracking component is configured to focus on a single composite object of the plurality of composite objects. The software application is configured to recognize the single composite object at the software application. The software application is configured to display data for the single composite object and a plurality of sub-composite objects for the single composite object on the display screen of the HMD device. The eye tracking component is configured to focusing on a single sub-composite object of the plurality of sub-composite objects. The software application is configured to recognize the single sub-composite object of the plurality of sub-composite objects at the software application. The software application is configured to display data for the single sub-composite object on the display screen of the HMD device.

The client device is preferably a personal computer, laptop computer, tablet computer or mobile computing device such as a smartphone.

The display device is preferably selected from the group comprising a desktop computer, a laptop computer, a tablet computer, a mobile phone, an AR headset, and a virtual reality (VR) headset.

Another embodiment is a method for identifying and using a hierarchy of targets in an augmented reality (“AR”) environment. The method includes identifying an object in an AR environment, the object focused on by a user wearing an AR head mounted display (“HMD”) device, the AR HMD device comprising a processor, a camera, a memory, a software application residing in the memory, an eye tracking component, an IMU, and a display screen; and identifying a plurality of composite objects of the object on the display screen of the AR HMD device using an identifier.

Another embodiment is a method for identifying and using a hierarchy of targets in a MR environment. The method includes identifying an object in an AR environment, the object focused on by a user wearing a head mounted display (“HMD”) device, the HMD device comprising a processor, a camera, a memory, a software application residing in the memory, an eye tracking component, an IMU, and a display screen; and identifying a plurality of composite objects of the object on the display screen of the HMD device using an identifier.

The identifier is preferably a visual identifier or an audio identifier.

The visual identifier is preferably an arrow, a label, a color change, or a boundary around the composite object.

The user interface elements include the capacity viewer and mode changer.

The methods may further comprise: focusing on a single composite object of the plurality of composite objects; recognizing the single composite object at the software application; displaying data for the single composite object and a plurality of sub-composite objects for the single composite object on the display screen of the AR or MR HMD device; focusing on a single sub-composite object of the plurality of sub-composite objects; recognizing the single sub-composite object of the plurality of sub-composite objects at the software application; and displaying data for the single sub-composite object on the display screen of the AR or MRHMD device.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages.

Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### OTHER ASPECTS

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human).

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

### RELATED APPLICATIONS

This application relates to the following related application(s): U.S. Pat. Appl. No. 62/517,900, filed Jun. 10, 2017, entitled METHOD AND APPARATUS FOR USING A HIERARCHY OF TARGETS IN AN AR ENVIRONMENT. The content of each of the related application(s) is hereby incorporated by reference herein in its entirety.

1. A method for using hierarchical relationships of different virtual content to determine sets of virtual content to generate and display on a virtual reality, augmented reality, or other user device, the method comprising
determining when a first user operating a first user device selects a first object of an environment;
identifying the first object from among a plurality of objects;
determining if a plurality of parts of virtual content are stored in association with the first object;
if the plurality of parts of the virtual content are stored in association with the first object, transmitting the plurality of parts of the virtual content to the first user device for display of the plurality of parts of the virtual content by the first user device;
determining when the first user operating the first user device selects a first part of the virtual content, from among the plurality of parts of the virtual content;
determining if one or more subparts of the first part of the virtual content are stored in association with the first part of the virtual content; and
if the one or more subparts of the first part of the virtual content are stored in association with the first part of the virtual content, transmitting the one or more subparts of the first part of the virtual content to the first user device for display of the one or more subparts of the first part of the virtual content by the first user device.

2. The method of claim 1, the method comprising:
displaying, on a screen of the first user device, the first part of the virtual content along with other parts of the plurality of parts of the virtual content; and
displaying, on the screen of the first user device, the one or more subparts of the first part of the virtual content.

3. The method of claim 1, wherein the virtual content includes a virtual representation of the first object.

4. The method of claim 1, wherein the plurality of parts of the virtual content include text, images, video, audio, static or animated visual representations of components of the first object, or other visual representation of data associated with the first object.

5. The method of claim 1, wherein the plurality of parts of the virtual content include visual representations of two or more components of the first object, wherein the first part of the virtual content comprises a first visual representation of a first component of the first object, and wherein the one or more subparts include one or more visual representation of one or more subcomponents of the first component.

6. The method of claim 1, wherein the plurality of parts of the virtual content include visual representations of two or more components of the first object, wherein the first part of the virtual content comprises a first visual representation of a first component of the first object, and wherein the one or more subparts include one or more of text, image, video or audio about the first component.

7. The method of claim 1, wherein the environment is a real environment, and wherein the first object is a real object in the real environment.

8. The method of claim 1, wherein the environment is a virtual environment, and wherein the first object is a virtual object in the virtual environment.

9. The method of claim 1, wherein the environment is a real environment, and wherein the first object is a virtual object displayed to appear as if the virtual object is in the real environment.

10. The method of claim 1, wherein determining when the first user operating the first user device selects the first object or the first part comprises:
determining if a gaze of the first user intersects with the first object or the first part for a predefined amount of time; and
if the gaze of the first user intersects with the first object or the first part for the predefined amount of time, determining that the first object or the first part is selected by the first user.

11. The method of claim 1, wherein determining when the first user operating the first user device selects the first object or the first part comprises:
determining if a gesture or audio input by the first user selects the first object or the first part; and
if a determination is made that the audio input by the first user selects the first object or the first part, determining that the first object or the first part is selected by the first user.

12. The method of claim 1, wherein determining when the first user operating the first user device selects the first object or the first part comprises:
determining if input by the first user generated using a glove, a controller or other peripheral device selects the first object or the first part; and
if a determination is made that the input by the first user generated using the glove, the controller or the other peripheral device selects the first object or the first part, determining that the first object or the first part is selected by the first user.

13. The method of claim 1, wherein determining when the first user operating the first user device selects the first object or the first part comprises:
determining if a condition is met; and
if the condition is met, determining that the first object or the first part is selected by the first user.

14. The method of claim 13, wherein the condition is determined to have been met when a position of the first user in the environment is within a predefined distance of a position of the first object or the first part in the environment.

15. The method of claim 13, wherein the condition is determined to have been met when the first object or the first part is inside a field of view of the first user.

16. The method of claim 13, wherein the condition is determined to have been met when the first user moves from an initial position of the first user in the environment towards the first object or the first part.

17. The method of claim 1, wherein the first object is among a plurality of objects in the environment.

18. The method of claim 1, the method comprising:
determining when a second user operating a second user device selects the first object;
transmitting the plurality of parts of the virtual content to the second user device for display of the plurality of parts of the virtual content by the second user device;
determining when the second user operating the second user device selects a second part of the virtual content, from the plurality of parts of the virtual content;
determining if one or more subparts of the second part of the virtual content are stored in association with the second part of the virtual content; and
if the one or more subparts of the second part of the virtual content are stored in association with the second part of the virtual content, transmitting the subparts of the second part of the virtual content to the second user device for display of the subparts of the second part of the virtual content by the second user device.

19. The method of claim 1, the method comprising:
determining when the first user operating the first user device selects a second part of the virtual content, from the plurality of parts of the virtual content;
determining if one or more subparts of the second part of the virtual content are stored in association with the second part of the virtual content; and
if the one or more subparts of the second part of the virtual content are stored in association with the second part of the virtual content, transmitting the subparts of the second part of the virtual content to the first user for display of the subparts of the second part of the virtual content by the first user device.

20. One or more non-transitory machine-readable media embodying program instructions that, when executed by one or more machines, cause the one or more machines to implement the method of claim 1.
